(19) United States
(12) Patent Application Publication
(10) Pub. No.: US 2009/0243543 A1
(43) Pub. Date: Oct. 1, 2009

(54) CHARGE AND DISCHARGE CONTROL CIRCUIT AND BATTERY DEVICE

(76) Inventors: Muneharu Kawana, Chiba-shi (JP); Atsushi Sakurai, Chiba-shi (JP); Kazuaki Sano, Chiba-shi (JP); Toshiyuki Koike, Chiba-shi (JP); Yoshihisa Tange, Chiba-shi (JP)

Correspondence Address: Brinks Hofer Gilson & Lione/Seiko Instruments Inc., P.O. Box 10395, Chicago, IL, 60611, US

(21) Appl. No.: 12/415,093

(22) Filed: Mar. 31, 2009

(30) Foreign Application Priority Data
Apr. 1, 2008 (JP) JP2008-094885

(51) Int. Cl. H02J 7/00

(52) U.S. Cl. 320/118; 320/134

(57) ABSTRACT

Provided is a charge and discharge control circuit capable of further preventing poor charge of a battery, and a battery device. Cell balance periods are detected before charge of respective batteries is stopped even when an overcharge detection voltage of a certain charge and discharge control circuit becomes lower than a cell balance period detection voltage thereof due to process variations occurring in mass production of the charge and discharge control circuits. That is, the charge of the respective batteries is stopped after cell balance control. Therefore, the respective batteries can be further prevented from being poorly charged.

### RELATED APPLICATIONS

This application claims priority under 35 U.S.C. §119 to Japanese Patent Application No. JP2008-094885 filed on Apr. 1, 2008, the entire content of which is hereby incorporated by reference.

### BACKGROUND OF THE INVENTION

1. Field of the Invention

The present invention relates to a charge and discharge control circuit which controls charge and discharge of a battery, and to a battery device.

2. Description of the Related Art

Nowadays, various portable electronic devices are widespread.

The portable electronic device has a battery device which supplies a power supply voltage thereto, and the battery device is equipped with a battery and a charge and discharge control circuit which controls charge and discharge of the battery.

In the charge and discharge control circuit, the battery is charged to increase a battery voltage of the battery, and an overcharged state of the battery is detected when the battery voltage becomes higher than an overcharge detection voltage. After that, control is performed to stop the charge. Further, the battery is charged to increase the battery voltage of the battery, and the battery voltage becomes higher than a cell balance period detection voltage, whereby a cell balance period of the battery is detected. After that, cell balance control is performed. Then, such a state in which the battery voltage of one battery becomes higher to be in the overcharged state during charge, and other batteries are poorly charged (for example, see JP 2004-088878 A) may be relieved.

However, in some cases, an overcharge detection voltage of one charge and discharge control circuit becomes lower than the cell balance period detection voltage due to process variations occurring in mass production of the charge and discharge control circuits. Accordingly, charge of respective batteries is stopped prior to the detection of the cell balance period. In other words, the charge of the respective batteries is stopped while the battery voltages thereof are different from each other.

Therefore, a charge and discharge control circuit capable of surely performing cell balance control and further of preventing the poor charge of the respective batteries, and a battery device are required.

### SUMMARY OF THE INVENTION

The present invention has been made in view of the above-mentioned problem, and provides a charge and discharge control circuit capable of further preventing poor charge of a battery, and a battery device.

In order to solve the above-mentioned problem, according to the present invention, there is provided a charge and discharge control circuit for controlling charge and discharge of a battery, including: an overcharge detecting circuit for detecting an overcharged state of the battery; a cell balance period detecting circuit for detecting a cell balance period at which cell balance control is performed so as to control charge speed of the battery to be slower; and a control circuit for controlling a charge stop switch disposed on a charge path for the battery to be turned off so that the charge of the battery is stopped when the overcharged state of the battery is detected while the cell balance period is being detected.

Further, in order to solve the above-mentioned problem, according to the present invention, there is provided a battery device, including: a plurality of batteries; a plurality of charge and discharge control circuits each controlling charge and discharge of each of the plurality of batteries, the plurality of charge and discharge control circuits each including: an overcharge detecting circuit for detecting an overcharged state of the each of the plurality of batteries; a cell balance period detecting circuit for detecting a cell balance period at which cell balance control is performed so as to control charge speed of the each of the plurality of batteries to be slower by turning on a cell balance control switch and discharging the each of the plurality of batteries; and a control circuit for controlling a charge stop switch to be turned off so that the charge stop switch is turned off to stop the charge of the each of the plurality of batteries when the overcharged state of the each of the plurality of batteries is detected while the cell balance period is being detected; another plurality of batteries; a plurality of the cell balance control switches connected in parallel with the another plurality of batteries; and another charge stop switch disposed on a charge path for the another plurality of batteries.

In the present invention, the detection of the cell balance periods is performed before charge of the respective batteries is stopped even when an overcharge detection voltage of one charge and discharge control circuit becomes lower than a cell balance period detection voltage thereof due to process variations occurring in mass production of the charge and discharge control circuits. That is, the charge of the respective batteries is stopped after the cell balance control. Accordingly, poor charge of the respective batteries can be prevented further.

### BRIEF DESCRIPTION OF THE DRAWINGS

In the accompanying drawings:

FIG. 1 is a block diagram illustrating a battery device;

FIG. 2 is a block diagram illustrating a charge and discharge control circuit;

FIG. 3 is a time chart illustrating voltages of respective batteries with respect to time; and

FIG. 4 is another time chart illustrating the voltages of the respective batteries with respect to time.

### DETAILED DESCRIPTION OF THE PREFERRED EMBODIMENTS

Hereinafter, with reference to the drawings, an embodiment of the present invention is described.

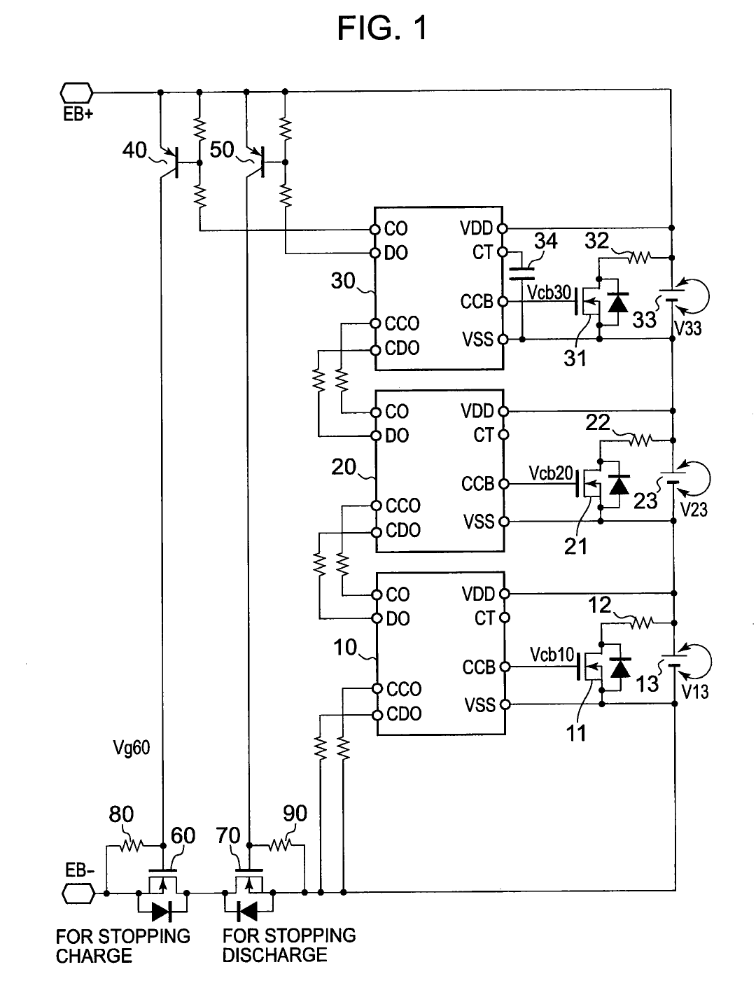

First, a configuration of a battery device is described. FIG. 1 is a block diagram illustrating the battery device.

The battery device includes a charge and discharge control circuit 10, an NMOS transistor (cell balance control switch) 11, a resistor 12, and a battery 13. The battery device includes a charge and discharge control circuit 20, an NMOS transistor (cell balance control switch) 21, a resistor 22, and a battery 23. The battery device includes a charge and discharge control circuit 30, an NMOS transistor (cell balance control switch) 31, a resistor 32, a battery 33, and a capacitor 34. The battery device includes a PNP bipolar transistor 40, a PNP bipolar transistor 50, an NMOS transistor (charge stop switch) 60, an NMOS transistor (discharge stop switch) 70, a resistor 80, and a resistor 90. The battery device further includes a terminal EB+ and a terminal EB−.

The NMOS transistor 60 and the NMOS transistor 70 are sequentially provided between the terminal EB− and a negative terminal of the battery 13. Specifically, the NMOS transistor 60 and the NMOS transistor 70 are provided on a charge and discharge path for the battery 33, the battery 23, and the battery 13. The battery 33, the battery 23, and the battery 13 are sequentially provided between the terminal EB+ and the terminal EB−. When those batteries are charged, a charger (not shown) is connected between the terminal EB+ and the terminal EB−. When those batteries are discharged, a load (not shown) is connected between the terminal EB+ and the terminal EB−.

The charge and discharge control circuit 10 includes a power supply terminal VDD connected to a positive terminal of the battery 13, a ground terminal VSS connected to the negative terminal of the battery 13, a control terminal C cell balance connected to a gate of the NMOS transistor 11, a control terminal CO connected to a control terminal CCO of the charge and discharge control circuit 20, and a control terminal DO connected to a control terminal CDO of the charge and discharge control circuit 20. Further, the charge and discharge control circuit 10 includes a control terminal CCO and a control terminal CDO which are connected to the negative terminal of the battery 13. The charge and discharge control circuit 20 includes a power supply terminal VDD connected to a positive terminal of the battery 23, a ground terminal VSS connected to a negative terminal of the battery 23, a control terminal C cell balance connected to a gate of the NMOS transistor 21, a control terminal CO connected a control terminal CCO of the charge and discharge control circuit 30, and a control terminal DO connected to a control terminal CDO of the charge and discharge control circuit 30. The charge and discharge control circuit 30 includes a power supply terminal VDD connected to a positive terminal of the battery 33, a ground terminal VSS connected to a negative terminal of the battery 33, a control terminal C cell balance connected to a gate of the NMOS transistor 31, a control terminal CO connected to a base of the PNP bipolar transistor 40, and a control terminal DO connected to a base of the PNP bipolar transistor 50. Further, the charge and discharge control circuit 30 includes a control terminal CT connected to the negative terminal of the battery 33 through the capacitor 34.

The NMOS transistor 11 includes a source connected to the negative terminal of the battery 13 and a drain connected to the positive terminal of the battery 13 through the resistor 12. Specifically, the NMOS transistor 11 is connected in parallel with the battery 13. The NMOS transistor 21 includes a source connected to the negative terminal of the battery 23 and a drain connected to the positive terminal of the battery 23 through the resistor 22. Specifically, the NMOS transistor 21 is connected in parallel with the battery 23. The NMOS transistor 31 includes a source connected to the negative terminal of the battery 33 and a drain connected to the positive terminal of the battery 33 through the resistor 32. Specifically, the NMOS transistor 31 is connected in parallel with the battery 33.

The PNP bipolar transistor 40 includes an emitter connected to the terminal EB+ and a collector connected to a gate of the NMOS transistor 60. The collector thereof is further connected to the terminal EB− through the resistor 80. The PNP bipolar transistor 50 includes an emitter connected to the terminal EB+ and a collector connected to a gate of the NMOS transistor 70. The collector thereof is further connected to the negative terminal of the battery 13 through the resistor 90.

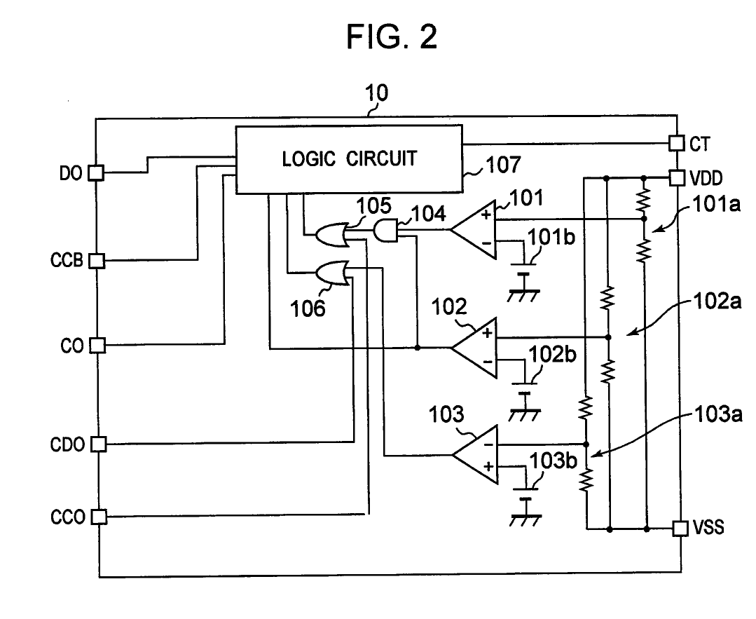

Next, a configuration of the charge and discharge control circuit 10 is described. FIG. 2 is a block diagram illustrating the charge and discharge control circuit.

The charge and discharge control circuit 10 includes voltage divider circuits 101a to 103a, reference voltage circuits 101b to 103b, an overcharge detecting comparator 101, a cell balance period detecting comparator 102, an overdischarge detecting comparator 103, an AND circuit 104, OR circuits 105 and 106, and a logic circuit 107. Further, the charge and discharge control circuit 10 includes the control terminal DO, the control terminal CO, the control terminal C cell balance, the control terminal CDO, the control terminal CCO, a control terminal CT, the power supply terminal VDD, and the ground terminal VSS.

Here, the voltage divider circuit 101a, the reference voltage circuit 101b, and the overcharge detecting comparator 101 form an overcharge detecting circuit. The voltage divider circuit 102a, the reference voltage circuit 102b, and the cell balance period detecting comparator 102 form a cell balance period detecting circuit. The voltage divider circuit 103a, the reference voltage circuit 103b, and the overdischarge detecting comparator 103 form an overdischarge detecting circuit. The AND circuit 104, the OR circuits 105 and 106, and the logic circuit 107 form a control circuit.

The overcharge detecting circuit detects an overcharged state of the battery 13. The cell balance period detecting circuit detects a cell balance period at which cell balance control is performed so as to control charge speed of the battery 13 to be slower by turning on the NMOS transistor 11 and discharging the battery 13. The overdischarge detecting circuit detects an overdischarged state of the battery 13. The control circuit controls the NMOS transistor 60 to be turned off so that the NMOS transistor 60 is turned off to stop charge of the battery 13 when the overcharged state of the battery 13 is detected while the cell balance period is being detected.

The voltage divider circuits 101a to 103a are provided between the power supply terminal VDD and the ground terminal VSS. The reference voltage circuit 101b is provided between an inverting input terminal of the overcharge detecting comparator 101 and the ground terminal VSS. The reference voltage circuit 102b is provided between an inverting input terminal of the cell balance period detecting comparator 102 and the ground terminal VSS. The reference voltage circuit 103b is provided between a non-inverting input terminal of the overdischarge detecting comparator 103 and the ground terminal VSS. The overcharge detecting comparator 101 includes a non-inverting input terminal connected to an output terminal of the voltage divider circuit 111a, and an output terminal connected to a first input terminal of the AND circuit 104. The cell balance period detecting comparator 102 includes a non-inverting input terminal connected to an output terminal of the voltage divider circuit 102a, and an output terminal connected to a second input terminal of the AND circuit 104 and a second input terminal of the logic circuit 107. The overdischarge detecting comparator 103 includes an inverting input terminal connected to an output terminal of the voltage divider circuit 103a, and an output terminal connected to a first input terminal of the OR circuit 106. The AND circuit 104 includes an output terminal connected to a first input terminal of the OR circuit 105. The OR circuit 105 includes a second input terminal connected to the control terminal CCO, and an output terminal connected to a first input terminal of the logic circuit 107. The OR circuit 106 includes a second input terminal connected to the control terminal CDO, and an output terminal connected to a third input terminal of the logic circuit 107. The logic circuit 107 includes a fourth input terminal connected to the control terminal CT, a first output terminal connected to the control terminal CO, a second output terminal connected to the control terminal C cell balance, and a third output terminal connected to the control terminal DO.

Next, an operation of the battery device is described.

When the battery 13 becomes the overcharged state while the cell balance control is being performed, a voltage of the control terminal CO of the charge and discharge control circuit 10 becomes high after a lapse of a delay time ΔTC. Then, a voltage of the control terminal CO of the charge and discharge control circuit 20 also becomes high, and a voltage of the control terminal CO of the charge and discharge control circuit 30 becomes high as well. Then, the PNP bipolar transistor 40 is turned off, and a gate voltage Vg60 of the NMOS transistor 60 is pulled down to be low by the resistor 80, whereby the NMOS transistor 60 is turned off. Accordingly, a discharge current is caused to flow by a parasitic diode of the NMOS transistor 60, but a charge current does not flow. That is, control is performed to stop the charge.

When the battery 13 is in a cell balance period, a voltage of the control terminal C cell balance of the charge and discharge control circuit 10 becomes high. Then, the NMOS transistor 11 is turned on. Accordingly, the battery 13 is discharged through the resistor 12 and the NMOS transistor 11. That is, the cell balance control is performed. Then, such a state in which a battery voltage V13 of the battery 13 becomes high to be in the overcharged state during the charge, and other batteries are poorly charged may be relieved.

When the battery 13 is in the overdischarged state, a voltage of the control terminal DO of the charge and discharge control circuit 10 becomes high after a lapse of the delay time. Then, a voltage of the control terminal DO of the charge and discharge control circuit 20 also becomes high, and a voltage of the control terminal DO of the charge and discharge control circuit 30 becomes high as well. Then, the PNP bipolar transistor 50 is turned off, a gate voltage of the NMOS transistor 70 is pulled down to be low by the resistor 90, with the result that the NMOS transistor 70 is turned off. Accordingly, the charge current is caused to flow by a parasitic diode of the NMOS transistor 70, but the discharge current does not flow. That is, control is performed to stop discharge.

Next, an operation of the charge and discharge control circuit 10 is described.

When the battery 13 is charged, a voltage of the power supply terminal VDD becomes high. Along with this, when an output voltage of the voltage divider circuit 101a also becomes high to be higher than a reference voltage of the reference voltage circuit 101b (when the battery voltage V13 becomes higher than an overcharge detection voltage), an output voltage of the overcharge detecting comparator 101 becomes high. As a result, the overcharged state of the battery 13 is detected. On this occasion, an output voltage of the AND circuit 104 becomes high and an output voltage of the OR circuit 105 also becomes high only in the case where an output voltage of the cell balance period detecting comparator 102 is high and the cell balance control is being performed. That is, the voltage of the control terminal CO becomes high only in the case where the cell balance control is being performed.

When an output voltage of the control terminal CCO becomes high, the overcharged state of the battery is detected in the other battery. On this occasion, the output voltage of the AND circuit 104 becomes high and the output voltage of the OR circuit 105 also becomes high only in the case where the output voltage of the cell balance period detecting comparator 102 is high and the cell balance control is being performed.

In the case of the charge and discharge control circuit 30, the voltage of the control terminal CO becomes high after a lapse of the delay time ΔTC caused by the capacitor 34 and the logic circuit 107.

Here, description is given of an operation of cell balance period detection in a case where a cell balance period detection voltage is lower than the overcharge detection voltage.

When the battery 13 is charged, the voltage of the power supply terminal VDD becomes high. Along with this, when an output voltage of the voltage divider circuit 102a also becomes high to be higher than a reference voltage of the reference voltage circuit 102b (when the battery voltage V13 becomes higher than the cell balance period detection voltage), the output voltage of the cell balance period detecting comparator 102 becomes high. As a result, a cell balance period of the battery 13 is detected. Then, the voltage of the control terminal C cell balance also becomes high by means of the logic circuit 107.

When the battery 13 is discharged, the voltage of the power supply terminal VDD becomes low. Along with this, when an output voltage of the voltage divider circuit 103a also becomes low to be lower than a reference voltage of the reference voltage circuit 103b (when the battery voltage V13 becomes lower than an overdischarge detection voltage), an output voltage of the overdischarge detecting comparator 103 becomes high. As a result, the overdischarged state of the battery 13 is detected. Then, an output voltage of the OR circuit 106 becomes high, and the voltage of the control terminal DO also becomes high.

When an output voltage of the control terminal CDO becomes high, the overdischarged state of the battery is detected in the other battery. Then, the output voltage of the OR circuit 106 becomes high, and the voltage of the control terminal DO also becomes high. In the case of the charge and discharge control circuit 30, the voltage of the control terminal DO also becomes high after a lapse of the delay time caused by the capacitor 34 and the logic circuit 107.

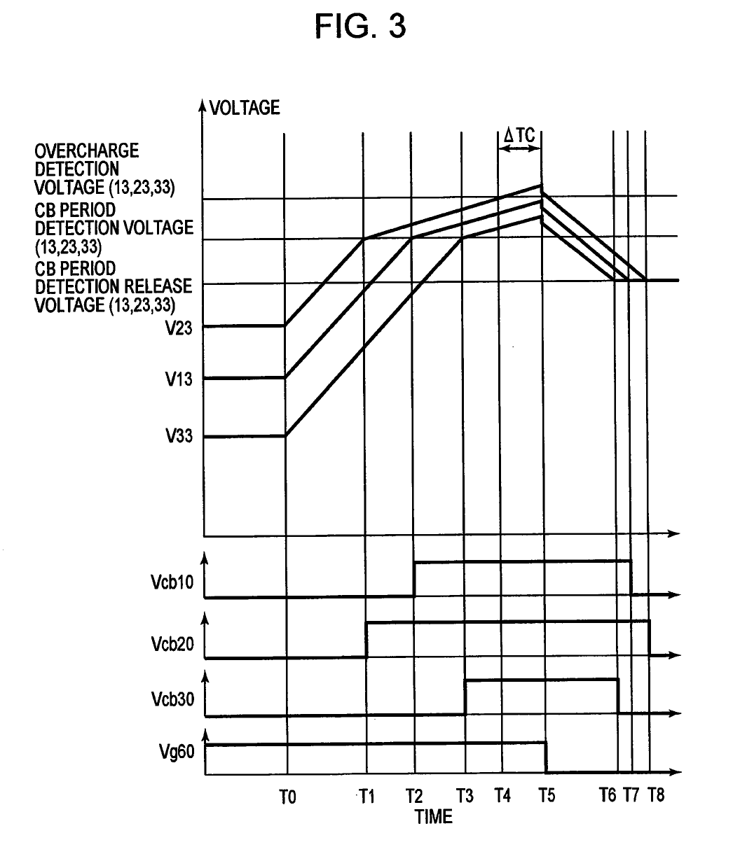

Next, description is given of the operation of the battery device in the case where the overcharge detection voltages of the battery 13, the battery 23, and the battery 33 are equal to each other, the cell balance period detection voltages thereof are equal to each other, and the overcharge detection voltages thereof are higher than the cell balance period detection voltages thereof. FIG. 3 is a time chart showing voltages of the respective batteries with respect to time.

At a time T0, the charger (not shown) is connected between the terminal EB+ and the terminal EB−, and the charger starts charging the battery 13, the battery 23, and the battery 33. Accordingly, the battery voltage V13, a battery voltage V23, and a battery voltage V33 become high.

At a time T1, the battery voltage V23 becomes equal to or larger than the cell balance period detection voltage of the battery 23, and a voltage V cell balance 20 becomes high. Then, the NMOS transistor 21 is turned on, whereby the battery 23 is discharged through the resistor 22 and the NMOS transistor 21. That is, charge speed of the battery 23 becomes slow.

At a time T2, the charge speed of the battery 13 becomes slow as in the case of the above.

At a time T3, charge speed of the battery 33 becomes slow as in the case of the above.

At a time T4, the battery voltage V23 becomes equal to or larger than the overcharge detection voltage of the battery 23.

At a time T5, the delay time ΔTC has passed from the time T4. The voltage of the control terminal CO of the charge and discharge control circuit 20 becomes high, and the voltage of the control terminal CO of the charge and discharge control circuit 30 also becomes high. Then, the PNP bipolar transistor 40 is turned off, and the gate voltage Vg60 of the NMOS transistor 60 becomes low, whereby the NMOS transistor 60 is turned off. Accordingly, the charge current is caused to flow by the parasitic diode of the NMOS transistor 60 while the battery 13 is discharged through the resistor 12 and the NMOS transistor 11, the battery 23 is discharged through the resistor 22 and the NMOS transistor 21, and the battery 33 is discharged through the resistor 32 and the NMOS transistor 31. However, the charge current does not flow, whereby the battery voltage V13, the battery voltage V23, and the battery voltage V33 become low.

At a time T6, the battery voltage V33 decreases to a cell balance period detection release voltage of the battery 33, and a voltage V cell balance 30 becomes low. Then, the NMOS transistor 31 is turned off, whereby the battery 33 is not discharged through the resistor 32 and the NMOS transistor 31. Accordingly, the battery voltage V33 becomes constant at the cell balance period detection release voltage of the battery 33.

At a time T7, the battery voltage V13 becomes constant at a cell balance period detection release voltage of the battery 13 as in the case of the above.

At a time T8, the battery voltage V23 becomes constant at a cell balance period detection release voltage of the battery 23 as in the case of the above.

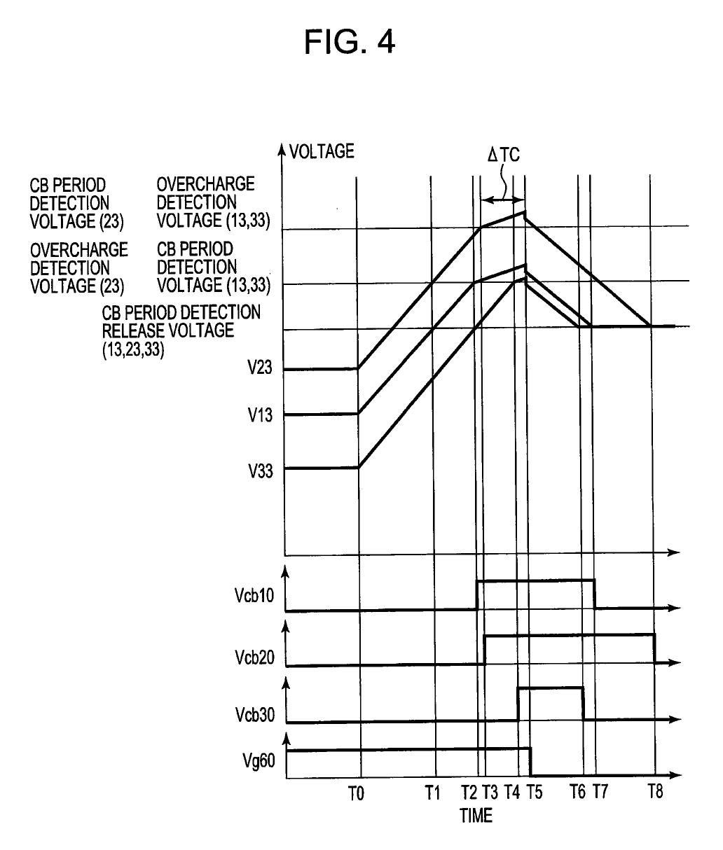

Next, description is given of the operation of the battery device in the case where the overcharge detection voltages of the battery 13 and the battery 33 are equal to the cell balance period detection voltage of the battery 23, the cell balance period detection voltages of the battery 13 and the battery 33 are equal to the overcharge detection voltage of the battery 23, and the overcharge detection voltages of the battery 13 and the battery 33 and the cell balance period detection voltage of the battery 23 are higher than the cell balance period detection voltages of the battery 13 and the battery 33 and the overcharge detection voltage of the battery 23. FIG. 4 is a time chart showing voltages of the respective batteries with respect to time.

At a time T0, the charger (not shown) is connected between the terminal EB+ and the terminal EB−, and the charger starts charging the battery 13, the battery 23, and the battery 33. Accordingly, the battery voltage V13, the battery voltage V23, and the battery voltage V33 become high.

At a time T1, the battery voltage V23 becomes equal to or larger than the overcharge detection voltage of the battery 23. However, the cell balance control is not performed, and thus the control is not performed to stop the charge.

At a time T2, the battery voltage V13 becomes equal to or larger than the cell balance period detection voltage of the battery 13, and a voltage V cell balance 10 becomes high. Then, the NMOS transistor 11 is turned on, whereby the battery 13 is discharged through the resistor 12 and the NMOS transistor 11. That is, the charge speed of the battery 13 becomes slow.

At a time T3, the charge speed of the battery 23 becomes slow as in the case of the above. Note that, at that time, the battery voltage V23 is regarded to become equal to or larger than the overcharge detection voltage of the battery 23.

At a time T4, the charge speed of the battery 33 becomes slow as in the case of the above.

At a time T5, the delay time ΔTC has passed from the time T3. The voltage of the control terminal CO of the charge and discharge control circuit 20 becomes high, and the voltage of the control terminal CO of the charge and discharge control circuit 30 also becomes high. Then, the PNP bipolar transistor 40 is turned off, and the gate voltage Vg60 of the NMOS transistor 60 becomes low, whereby the NMOS transistor 60 is turned off. Accordingly, the charge current is caused to flow by the parasitic diode of the NMOS transistor 60 while the battery 13 is discharged through the resistor 12 and the NMOS transistor 11, the battery 23 is discharged through the resistor 22 and the NMOS transistor 21, and the battery 33 is discharged through the resistor 32 and the NMOS transistor 31. However, the charge current does not flow, whereby the battery voltage V13, the battery voltage V23, and the battery voltage V33 become low.

At a time T6, the battery voltage V33 decreases to the cell balance period detection release voltage of the battery 33, and the voltage V cell balance 30 becomes low. Then, the NMOS transistor 31 is turned off, whereby the battery 33 is not discharged through the resistor 32 and the NMOS transistor 31. Accordingly, the battery voltage V33 becomes constant at the cell balance period detection release voltage of the battery 33.

At a time T7, the battery voltage V13 becomes constant at the cell balance period detection release voltage of the battery 13 as in the case of the above.

At a time T8, the battery voltage V23 becomes constant at the cell balance period detection release voltage of the battery 23 as in the case of the above.

As can be seen, the cell balance periods are detected before the charge of the respective batteries is stopped even when the overcharge detection voltage of a certain charge and discharge control circuit becomes lower than the cell balance period detection voltage thereof due to process variations occurring in mass production of the charge and discharge control circuits. That is, the charge of the respective batteries is stopped after the cell balance control. Therefore, the respective batteries can be further prevented from being poorly charged.

What is claimed is:

1. A charge and discharge control circuit for controlling charge and discharge of a battery, comprising:
an overcharge detecting circuit for detecting an overcharged state of the battery;
a cell balance period detecting circuit for detecting a cell balance period at which cell balance control is performed so as to control charge speed of the battery to be slower; and
a control circuit for controlling a charge stop switch disposed on a charge path for the battery to be turned off so that the charge of the battery is stopped when the overcharged state of the battery is detected while the cell balance period is being detected.

2. A battery device, comprising:
a plurality of batteries;
a plurality of charge and discharge control circuits each controlling charge and discharge of each of the plurality of batteries,
the plurality of charge and discharge control circuits each comprising:
an overcharge detecting circuit for detecting an overcharged state of the each of the plurality of batteries;
a cell balance period detecting circuit for detecting a cell balance period at which cell balance control is performed so as to control charge speed of the each of the plurality of batteries to be slower by turning on a cell balance control switch and discharging the each of the plurality of batteries; and
a control circuit for controlling a charge stop switch to be turned off so that the charge stop switch is turned off to stop the charge of the each of the plurality of batteries when the overcharged state of the each of the plurality of batteries is detected while the cell balance period is being detected;
another plurality of batteries;
a plurality of the cell balance control switches connected in parallel with the another plurality of batteries; and
another charge stop switch disposed on a charge path for the another plurality of batteries.
